(19) United States
(12) Patent Application Publication
(10) Pub. No.: US 2006/0285280 A1
(43) Pub. Date: Dec. 21, 2006

(54) Fuse box having a quick indication function

(76) Inventor: Chuan Shyu, Taichung (TW)

Correspondence Address: NIKOLAI & MERSEREAU, P.A., 900 SECOND AVENUE SOUTH, SUITE 820, MINNEAPOLIS, MN, 55402, US

(21) Appl. No.: 10/643,479

(22) Filed: Aug. 15, 2003

(51) Int. Cl. H01H 85/30

(52) U.S. Cl. 361/628; 361/630; 337/206

(57) ABSTRACT

A fuse box includes a main body, a plurality of fuses mounted on the main body, and a plurality of light emitting diodes each mounted on the main body and each electrically connected with a respective one of the fuses. Thus, when one of the fuses is fused, the respective light emitting diode will light to produce an indication effect, so that the operator can simultaneously identify the melted fuse easily and rapidly by indication of the respective light emitting diode, so as to replace the melted fuse, thereby facilitating maintenance of the fuse.

### BACKGROUND OF THE INVENTION

1. Field of the Invention

The present invention relates to a fuse box, and more particularly to a fuse box having a quick indication function.

2. Description of the Related Art

A conventional fuse box in accordance with the prior art shown in FIG. 5 comprises a main body 80, and a top cover 90 mounted on the main body 80. The main body 80 is provided with a plurality of fuses 82, and a plurality of receiving seats 81 for receiving the fuses 82. Thus, when one of the loads breaks down or when the whole electric circuit forms a short circuit, the respective fuse 82 is melted to form a disconnection state, so as to protect the load.

However, the conventional fuse box does not have an indication function, so that the operator cannot correctly identify which one of the fuses 82 is worn out, thereby greatly causing inconvenience to the operator in maintenance and replacement of the fuses 82.

### SUMMARY OF THE INVENTION

The primary objective of the present invention is to provide a fuse box having a quick indication function.

Another objective of the present invention is to provide a fuse box, wherein when one of the fuses is fused to form a disconnection state, the respective light emitting diode will light to produce an indication effect, so that the operator can simultaneously identify the melted fuse easily and rapidly by indication of the respective light emitting diode, so as to replace the melted fuse, thereby facilitating maintenance of the fuse.

A further objective of the present invention is to provide a fuse box, wherein each of the light emitting diodes has a relatively high resistance, so that the electric current passing through the light emitting diode and the respective load is very small, thereby preventing the load from being worn out.

A further objective of the present invention is to provide a fuse box, wherein the indication lamp can light when either one of the fuses is melted or worn out so as to notify the operator one of the fuses is worn out.

A further objective of the present invention is to provide a fuse box, wherein the indication lamp has a color different from that of each of the light emitting diodes, thereby forming a double indication effect.

In accordance with the present invention, there is provided a fuse box, comprising:

a main body;

a plurality of fuses mounted on the main body; and

a plurality of light emitting diodes each mounted on the main body and each electrically connected with a respective one of the fuses.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a fuse box in accordance with the preferred embodiment of the present invention;

FIG. 2 is a partially exploded perspective view of the fuse box in accordance with the preferred embodiment of the present invention;

FIG. 3 is a circuit diagram of the fuse box in accordance with the preferred embodiment of the present invention;

FIG. 4 is a schematic operational view of the fuse box as shown in FIG. 1 in use; and

FIG. 5 is a partially exploded perspective view of a conventional fuse box in accordance with the prior art.

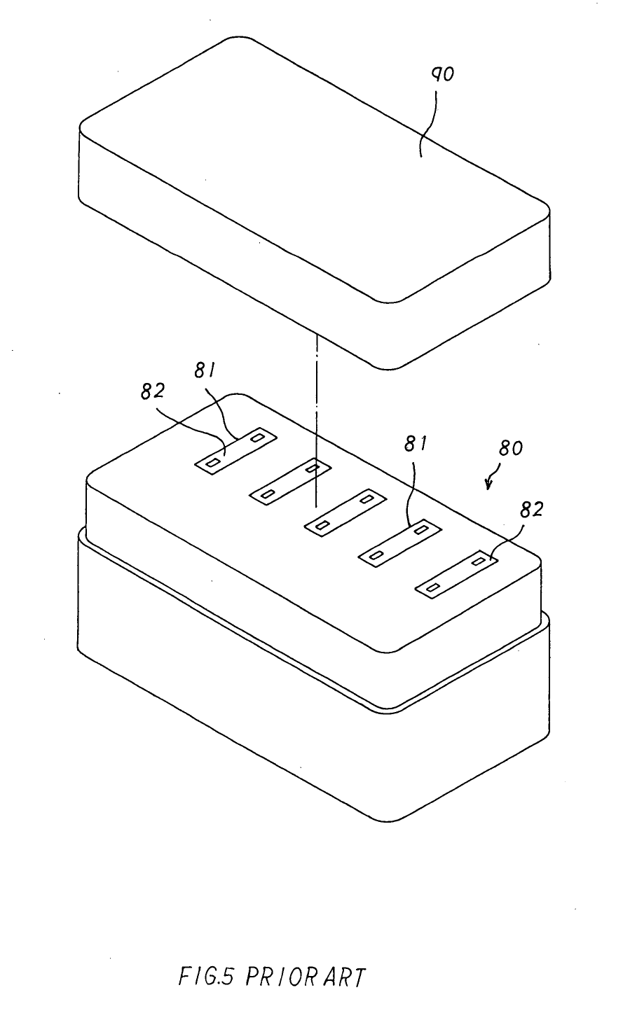

### DETAILED DESCRIPTION OF THE INVENTION

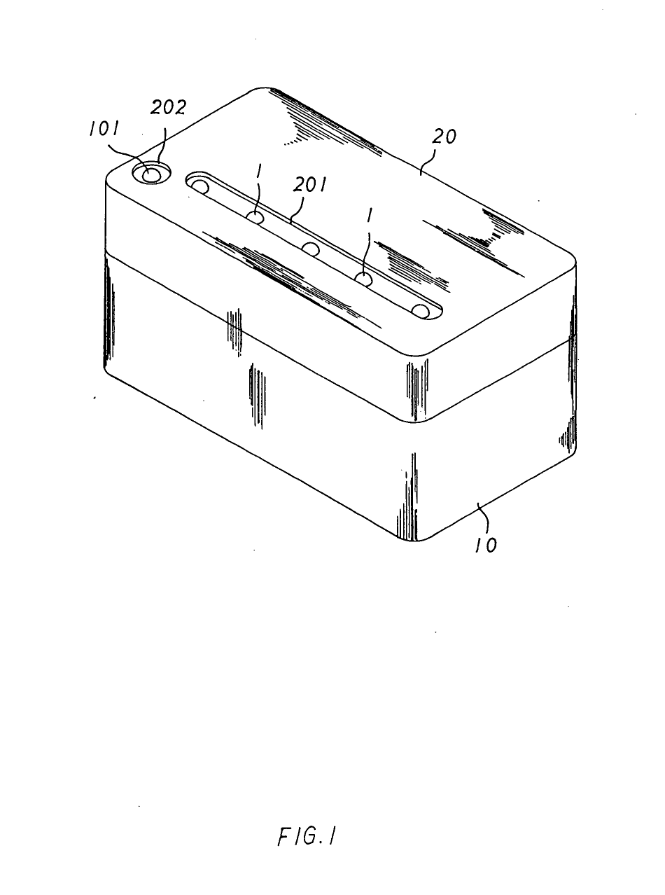

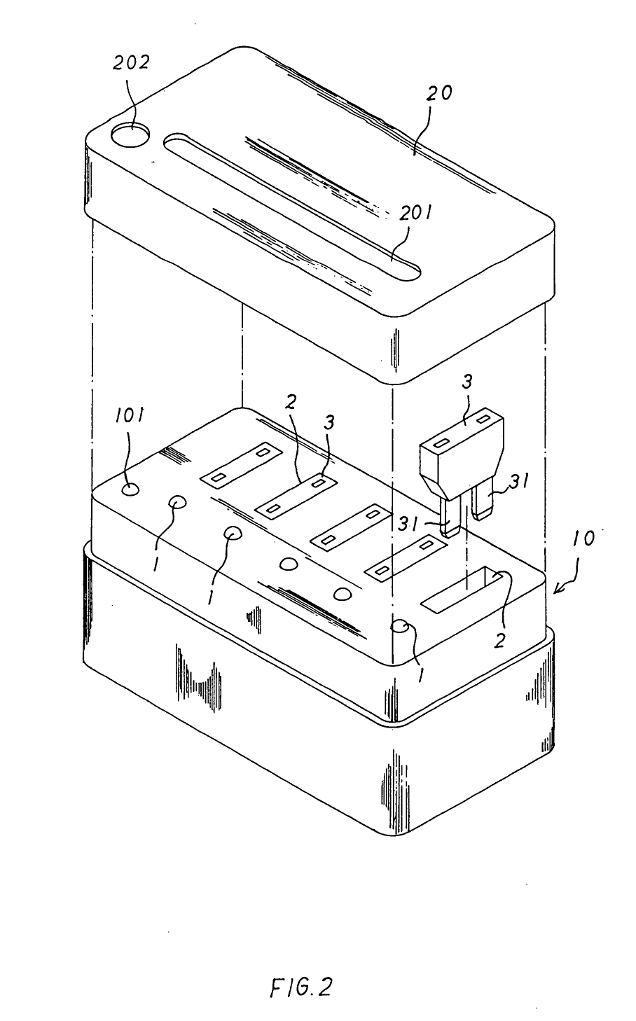

Referring to the drawings and initially to FIGS. 1-3, a fuse box in accordance with the preferred embodiment of the present invention comprises a main body 10, and a top cover 20 mounted on a top of the main body 10.

The main body 10 is provided with a plurality of fuses 3, and a plurality of light emitting diodes 1 each electrically connected with a respective one of the fuses 3. Each of the light emitting diodes 1 has a relatively high resistance and is electrically connected with a respective one of the fuses 3 in a parallel manner. The main body 10 is provided with a plurality of receiving seats 2, and each of the fuses 3 is received in a respective one of the receiving seats 2. Each of the fuses 3 has two conducting blades 31, and each of the light emitting diodes 1 is electrically connected with the two conducting blades 31 of a respective one of the fuses 3.

In addition, each of the light emitting diodes 1 has a resistance much greater than that each of the fuses 3. Thus, at the normal state, the electric current from the power supply directly passes through each of the fuses 3 without passing through the respective light emitting diode 1.

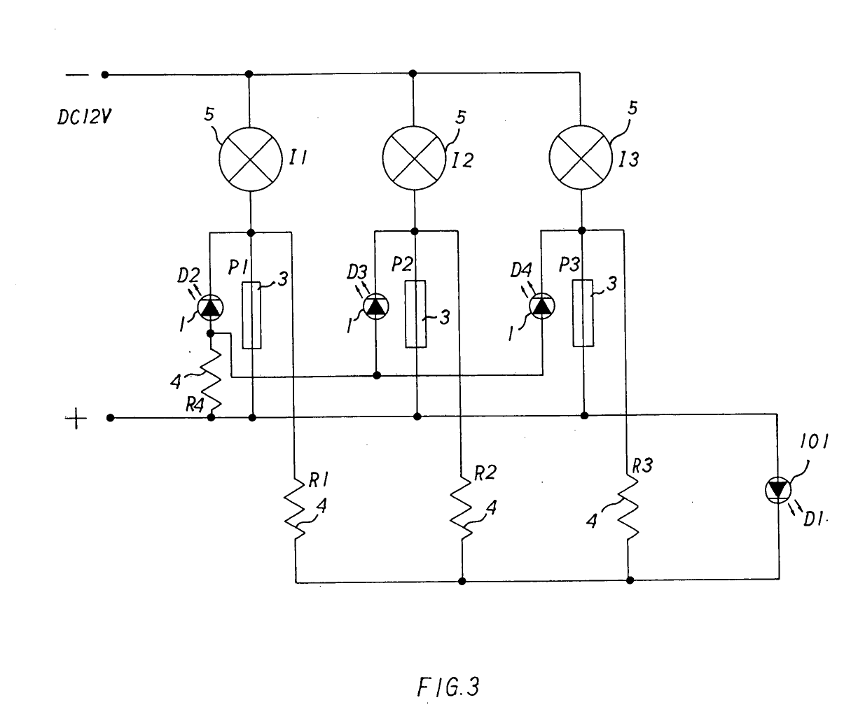

After one of the fuses 3 is fused to form a disconnection state, the electric current from the power supply is forced to pass through the respective light emitting diode 1, so that the respective light emitting diode 1 will light to produce an indication effect. Thus, the operator can simultaneously identify the melted fuse 3 easily and rapidly by indication of the respective light emitting diode 1, so as to replace the melted fuse 3, thereby facilitating maintenance of the fuse 3. In addition, each of the light emitting diodes 1 has a relatively high resistance, so that the electric current passing through the light emitting diode 1 and the respective load 5 (see FIG. 3) is very small, thereby preventing the load 5 from being worn out.

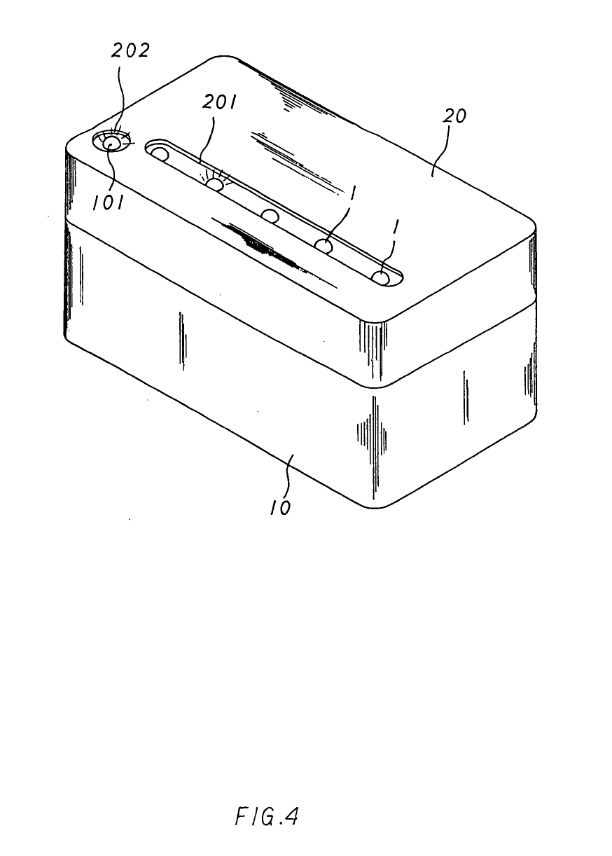

The top cover 20 is formed with an elongated window 201 aligning with the light emitting diodes 1, thereby facilitating the operator inspecting operation of the light emitting diodes 1 as shown in FIG. 4.

In addition, each of the light emitting diodes 1 is connected with a resistor 4 having a relatively high resistance, so that each of the light emitting diodes 1 has a relatively high resistance.

The fuse box further comprises an indication lamp 101 mounted on the main body 10 and electrically connected with each of the fuses 3 in a serial manner, so that the indication lamp 101 can light when either one of the fuses 3 is melted or worn out so as to notify the operator one of the fuses 3 is worn out. Preferably, the indication lamp 101 is a light emitting diode. Preferably, the indication lamp 101 has a color different from that of each of the light emitting diodes 1, thereby forming a double indication effect.

The top cover 20 is formed with an indication window 202 aligning with the indication lamp 101, thereby facilitating the operator inspecting operation of the indication lamp 101 as shown in FIG. 4.

As shown in FIG. 4, the fuse box comprises three loads I1, I2 and I3, four resistors R1, R2, R3 and R4, four light emitting diodes D1, D2, D3 and D4, and three fuses P1, P2 and P3. When the load 11 breaks down, the fuse P1 is melted, so that the current cannot flow into the load I1. At this time, the voltage (DC 12V) of the power supply is dropped by the resistor R4 and then supplies the electric power to the light emitting diode D2, so that the light emitting diode D2 will light so as to notify the operator that the fuse P1 is worn out. At the same time, the voltage of the power supply is also dropped by the resistor R1 and then supplies the electric power to the light emitting diode D1, so that the light emitting diode D1 will light. Thus, the light emitting diode D1 will light when either one of the three fuses P1, P2 and P3 is worn out to provide a double indication effect.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A fuse box, comprising:
a main body;
a plurality of fuses mounted on the main body; and
a plurality of light emitting diodes each mounted on the main body and each electrically connected with a respective one of the fuses.

2. The fuse box in accordance with claim 1, wherein each of the light emitting diodes has a relatively high resistance.

3. The fuse box in accordance with claim 1, wherein each of the light emitting diodes is electrically connected with a respective one of the fuses in a parallel manner.

4. The fuse box in accordance with claim 1, wherein the main body is provided with a plurality of receiving seats, and each of the fuses is received in a respective one of the receiving seats.

5. The fuse box in accordance with claim 1, wherein each of the fuses has two conducting blades, and each of the light emitting diodes is electrically connected with the two conducting blades of a respective one of the fuses.

6. The fuse box in accordance with claim 1, wherein each of the light emitting diodes has a resistance much greater than that each of the fuses.

7. The fuse box in accordance with claim 1, wherein the electric current from a power supply passes through each of the fuses at the normal state without passing through the respective light emitting diode, and after one of the fuses is fused to form a disconnection state, the electric current from the power supply is forced to pass through the respective light emitting diode, so that the respective light emitting diode will light to produce an indication effect.

8. The fuse box in accordance with claim 1, further comprising a top cover mounted on a top of the main body and formed with an elongated window aligning with the light emitting diodes.

9. The fuse box in accordance with claim 1, further comprising an indication lamp mounted on the main body and electrically connected with each of the fuses in a serial manner, so that the indication lamp can light when either one of the fuses is worn out

10. The fuse box in accordance with claim 9, wherein the indication lamp is a light emitting diode.

11. The fuse box in accordance with claim 9, wherein the indication lamp has a color different from that of each of the light emitting diodes.

12. The fuse box in accordance with claim 9, further comprising a top cover mounted on a top of the main body and formed with an indication window aligning with the indication lamp.

13. The fuse box in accordance with claim 1, wherein each of the light emitting diodes is connected with a resistor having a relatively high resistance.
